(19) United States
(12) Patent Application Publication
(10) Pub. No.: US 2013/0046470 A1
(43) Pub. Date: Feb. 21, 2013

(54) METHOD AND APPARATUS OF DEVELOPING HIGH-RESOLUTION SOLAR METEOROLOGICAL RESOURCE MAP BASED ON METEOROLOGICAL DATA

(71) Applicants: Joon-Bum JEE, Seoul (KR); Kyu-Tae LEE, Gangneung-si (KR); Young-Jean CHOI, Seoul (KR); Il-Sung ZO, Gangneung-si (KR); Young-San PARK, Seoul (KR); Seung-Woo LEE, Seoul (KR)

(72) Inventors: Joon-Bum JEE, Seoul (KR); Kyu-Tae LEE, Gangneung-si (KR); Young-Jean CHOI, Seoul (KR); Il-Sung ZO, Gangneung-si (KR); Young-San PARK, Seoul (KR); Seung-Woo LEE, Seoul (KR)

(73) Assignee: KOREA METEOROLOGICAL ADMINISTRATION, Seoul (KR)

(21) Appl. No.: 13/588,597

(22) Filed: Aug. 17, 2012

(30) Foreign Application Priority Data
Aug. 18, 2011 (KR) 10-2011-0082156

(51) Int. Cl. G06F 19/00

(52) U.S. Cl. 702/3

(57) ABSTRACT

Provided are a method and an apparatus of developing a high-resolution solar meteorological resource map based on meteorological data, the method comprisingincluding: generating a grid with a predetermined length for a selected region on a map and setting resolution corresponding to a size of the grid; converting digital elevation model data and albedo data of the earth's surface into the resolution corresponding to the size of the grid; converting meteorological data into the resolution corresponding to the size of the grid; calculating a global solar radiation using the digital elevation model data, the albedo data of the earth's surface and the meteorological data as converted above; accumulating the calculated global solar radiation during a fixed period; and generating a solar meteorological resource map using the accumulated global solar radiation.

### BACKGROUND OF THE INVENTION

1. Field of the Invention

The present invention relates to a method and an apparatus of developing a solar meteorological resource map, more specifically, to a method and an apparatus of developing a high-resolution solar meteorological resource map based on meteorological data.

2. Description of the Related Art

The need of alternative energy resulting from a climatic change, global warming and energy depletion has recently arisen. The nuclear power generation has high efficiency, but faces any difficulty in its later development and use due to a risk caused by destruction of the Japanese nuclear power generation and radioactivity leakage resulting from the recent tsunami. Furthermore, wind energy or solar energy as clean energy is being emphasized as new and renewable energy which can be infinitely developed, but its efficiency is not still satisfactory.

Like this, in the solar energy generation, the location selection of photovoltaic power generation facilities or the installation of generation equipment are important factors for photovoltaic power generation, and a solar meteorological resource map formed using observed data in the past has been used as important basic data for photovoltaic power generation. Furthermore, the solar meteorological resource map has been used for the location selection of photovoltaic power generation facilities, and the investigation and the operation of generation business operators' profitability.

Since the photovoltaic power generation facilities are not fluid, it would be necessary to investigate their validity and profitability before installing them. Particularly, in the case of the photovoltaic power generation of mountains or regions having the complex topography, high resolution information is greatly needed.

However, because the distribution of a solar radiation which is generally prepared is climatic and its resolution is very low, its accuracy is limited.

### SUMMARY OF THE INVENTION

In an aspect of the present invention, a high-resolution solar meteorological resource map having higher accuracy is formed using input data and meteorological data regarding a solar energy reaching the earth's surface, and is used for basic researches such as energy generation researches, radiation observation, climate data processing and the like.

In accordance with an aspect of the present invention, there is provided a method of developing a high-resolution solar meteorological resource map based on meteorological data comprising: generating a grid with a predetermined length to a selected region on a map and setting resolution corresponding to a size of the grid; converting digital elevation model data and albedo data of the earth's surface into the resolution corresponding into the size of the grid; converting meteorological data into the resolution corresponding to the size of the grid; calculating a global solar radiation using the digital elevation model data, the albedo data of the earth's surface and the meteorological data as converted above; accumulating the calculated global solar radiation during a fixed period; and generating a solar meteorological resource map using the accumulated global solar radiation.

In accordance with another aspect of the present invention, there is provided an apparatus for developing a high-resolution solar meteorological resource map based on meteorological data comprising: a resolution setting unit for generating a grid with a predetermined length to a selected region on a map and setting resolution corresponding to a size of the grid; a basic data processing unit for converting digital elevation model data, albedo data of the earth's surface into the resolution corresponding to the size of the grid; a meteorological data processing unit for converting meteorological data into the resolution corresponding to the size of the grid; a solar radiation calculating unit for calculating a global solar radiation using the digital elevation model data, the albedo data of the earth's surface, and the meteorological data as converted above; a solar radiation processing unit for accumulating the calculated global solar radiation during a fixed period; and a solar meteorological resource map generating unit for generating a solar meteorological resource map using the accumulated global solar radiation.

In accordance with exemplary embodiments of the present invention, the high-resolution solar meteorological resource map having higher accuracy is formed using input data regarding a solar energy reaching the earth's surface and meteorological data, which can be used for basic researches such as energy generation researches, radiation observation and climate data processing.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flow chart for explaining a method of developing a high-resolution solar meteorological resource map based on meteorological data according to an exemplary embodiment of the present invention.

FIG. 2 is a schematic view illustrating an apparatus of developing a high-resolution solar meteorological resource map based on meteorological data according to another exemplary embodiment of the present invention.

### DETAILED DESCRIPTION OF THE INVENTION

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Same reference numerals presented in each drawing represent same members.

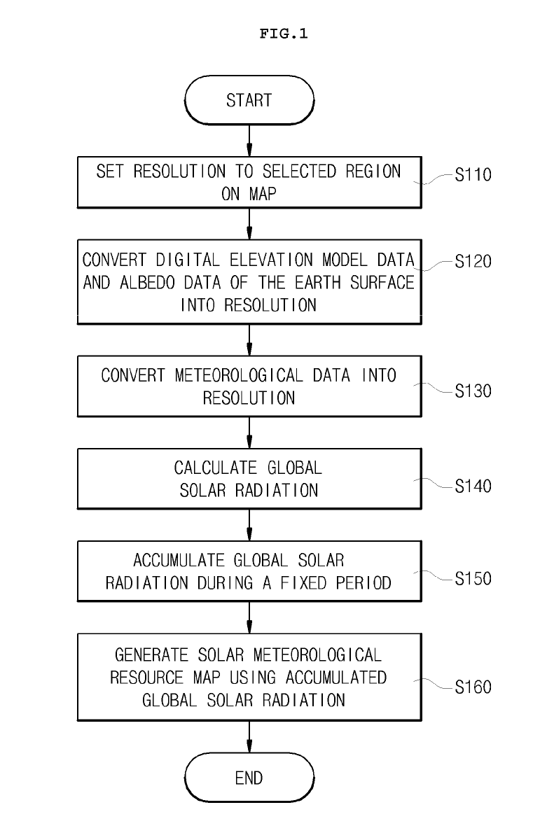

FIG. 1 is a flow chart for explaining a method of developing a high-resolution solar meteorological resource map based on meteorological data according to an exemplary embodiment of the present invention. The method of developing a high-resolution solar meteorological resource map based on meteorological data is explained with reference to FIG. 1.

The method of developing a high-resolution solar meteorological resource map based on meteorological data according to the present exemplary embodiment of the invention includes generating a grid with a predetermined length to a selected region on a map and setting resolution corresponding to a size of the grid (S110).

At this time, for example, the grid may be generated at an interval of 1 km or an interval of 4 km to a region ranging from 33° N to 43° N and a region ranging from 123° E to 133° E including the Korean peninsula. Furthermore, resolution may be set to correspond to the size of the grid.

Since then, digital elevation model data and albedo data of the earth's surface is converted into the resolution corresponding to the size of the space grid by performing interpolation or extrapolation (S120). At this time, the digital elevation model data and the albedo data of the earth's surface are basic data having a small time change.

For example, when the digital elevation model data are formed at an interval of 3 seconds (90 m resolution), the data may be converted into resolution of a 1 km grid by performing extrapolation. Furthermore, when the albedo data of the earth's surface is formed at an interval of 30 seconds (900 m resolution), the data may be converted into resolution of a 1 km grid by performing extrapolation.

Since then, meteorological data is converted into the resolution corresponding to the size of the grid (S130). At this time, the meteorological data are ozone data, aerosol data, precipitable water data, temperature data, atmospheric pressure data, sea-level atmospheric data and cloud data.

Explaining more specifically, the meteorological data may be converted according to each predetermined time by performing interpolation or extrapolation depending on each time. For example, the ozone data may convert 1°×1° resolution data on a daily basis day observed using an OMI (Ozone Monitoring Instrument) sensor of the AURA satellite into 1 km resolution data with an interval of 1 hour. The aerosol data may convert 1°×1° resolution data on a daily basis observed using an MODIS (Moderate Resolution Imaging Spectroradiometer) sensor of the AURA and TERA satellites into 1 km resolution data with an interval of 1 hour. The precipitable water data may convert data calculated by performing a vertical accumulation using the atmospheric pressure data and a mixing ratio of vapor with an interval of 5 km on a 3 hours basis of a numerical model of the KLAPS (Korea Local Analysis and Prediction System) of the Meteorological Administration into 1 km resolution data with an interval of 1 hour. Furthermore, the temperature data, the atmospheric pressure data and the sea-level atmospheric pressure data may convert data with an interval of 5 km on a 3 hours basis of a numerical model of the KLAPS of the Korea Meteorological Administration into 1 km resolution with an interval of 1 hour. The cloud data may determine cloud using data of MTSAT-1R and MTSAT-2 which are received by the Meteorological Administration and are provided to users and may be converted into 1 km resolution with an interval of 1 hour by calculating an amount of cloud using a solar zenith angle and a relationship with the visible reflectance of visible channels of satellite data.

Since then, a global solar radiation is calculated using the digital elevation model data, the albedo data of the earth's surface, and the meteorological data as converted above (S140). At this time, a direct solar radiation and a diffuse solar radiation are calculated using the digital elevation model data, the albedo data of the earth's surface, and the meteorological data as converted above. The global solar radiation may be calculated using the calculated direct solar radiation and diffuse solar radiation.

The global solar radiation as calculated above is accumulated during a fixed period (S150). At this time, the calculated global solar radiation may be accumulated on a daily, monthly or yearly basis. Furthermore, the direct solar radiation and the diffuse solar radiation may be separately accumulated.

Accordingly, the solar meteorological resource map may be generated using the global solar radiation as accumulated above (S160). In addition to this, the solar meteorological resource map may be generated using the direct solar radiation or the diffuse solar radiation. Furthermore, the solar meteorological resource map as generated above may be converted to be appropriate for its use purposes such as changing resolution or a unit or applying an amendment value.

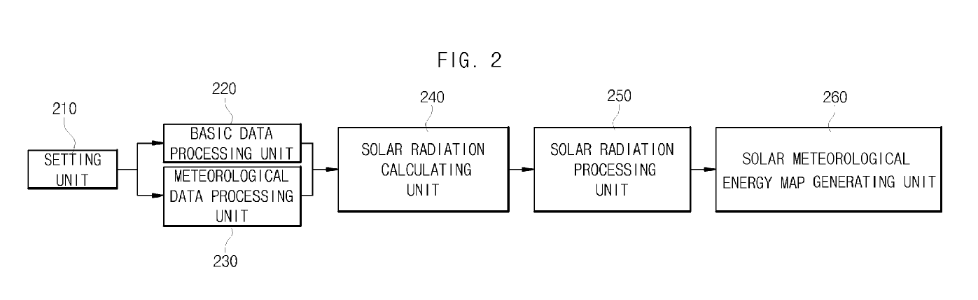

FIG. 2 is a construction view illustrating an apparatus of developing a high-resolution solar meteorological resource map based on meteorological data according to another exemplary embodiment of the present invention. The apparatus of developing a high-resolution solar meteorological resource map based on meteorological data is explained with reference to FIG. 2.

As illustrated in FIG. 2, the apparatus of developing a high-resolution solar meteorological resource map based on meteorological data according to the present exemplary embodiment of the invention may include a setting unit 210, a basic data processing unit 220, a meteorological data processing unit 230, a solar radiation calculating unit 240, a solar radiation processing unit 250, and a solar meteorological resource map generating unit 260.

The setting unit 210 generates a grid with a predetermined length to a selected region on a map and sets resolution corresponding to a size of the grid.

At this time, the setting unit 210 may generate, for example, a grid at an interval of 1 km or an interval of 4 km to a region ranging from 33° N to 43° N, and a region ranging from 123° E to 133° E including the Korean peninsula, and may set resolution so as to correspond to the size of the grid. Furthermore, unlike this, the setting unit 210 may be configured such that the grid is generated in a size of a grid used in a geostationary satellite.

The basic data processing unit 220 converts the digital elevation model data and the albedo data of the earth's surface into the resolution corresponding to the size of the grid.

At this time, the basic data processing unit 220 may convert the digital elevation model data and the albedo data of the earth's surface using a basic data processing course having a small change depending on each time by performing interpolation or extrapolation depending on each space. For example, the basic data processing unit 220 may convert the digital elevation model data into the resolution of a 1 km grid by performing extrapolation when the digital elevation model data are formed at an interval of 3 seconds (90 m resolution), or may convert the albedo data of the earth's surface into the resolution of a 1 km grid by performing extrapolation when the albedo data of the earth' surface are formed at an interval of 30 seconds (900 m resolution).

The meteorological data processing unit 230 converts the meteorological data into the resolution corresponding to the size of the grid.

The meteorological data processing unit 230 may convert the ozone data, aerosol data, precipitable water data, the temperature data, the atmospheric pressure data, sea-level atmospheric pressure data and the cloud data into the resolution corresponding to the size of the grid. That is, for example, when the setting unit 210 sets the resolution as 1 km resolution with an interval of 1 hour, the meteorological data processing unit 230 sets the meteorological data into the 1 km resolution with the interval of 1 hour like the above.

The solar radiation calculating unit 240 calculates a global solar radiation using the digital elevation model data, the albedo data of the earth's surface and the meteorological data as converted above. At this time, the solar radiation calculating unit 240 calculates a direct solar radiation and a diffuse solar radiation using the digital elevation model data, the albedo data of the earth's surface and the meteorological data as converted above. The global solar radiation may be calculated using the direct solar radiation and the diffuse solar radiation as calculated above.

The solar radiation processing unit 250 accumulates the global solar radiation as calculated above during a fixed period.

At this time, the solar radiation processing unit 250 may accumulate the calculated global solar radiation on a daily, monthly or yearly basis, or may separately accumulate the direct solar radiation and the diffuse solar radiation.

The solar meteorological resource map generating unit 260 may generate the solar meteorological resource map using the global solar radiation as accumulated above. Furthermore, the solar meteorological resource map generating unit 260 may generate the solar meteorological resource map using the direct solar radiation and the diffuse solar radiation. The generated solar meteorological resource map may be modified to be appropriate for its use purposes such as changing resolution or a unit, or applying an amendment value.

As previously described, in the detailed description of the invention, having described the detailed exemplary embodiments of the invention, it should be apparent that modifications and variations can be made by persons skilled without deviating from the spirit or scope of the invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims and their equivalents.

1. A method of developing a high-resolution solar meteorological resource map based on meteorological data comprising:
generating a grid with a predetermined length to a selected region on a map and setting resolution corresponding to a size of the grid;
converting digital elevation model data and albedo data of the earth's surface into the resolution corresponding to the size of the grid;
converting meteorological data into the resolution corresponding to the size of the grid;
calculating a global solar radiation using the digital elevation model data, the albedo data of the earth's surface and the meteorological data as converted above;
accumulating the calculated global solar radiation during a fixed period; and
generating a solar meteorological resource map using the accumulated global solar radiation.

2. The method of claim 1, wherein the setting of the resolution corresponding to the size of the grid includes setting of the resolution corresponding to the size of the grid to generate the grid in a size of a grid used in a geostationary satellite.

3. The method of claim 1, wherein the setting of the resolution corresponding to the size of the grid includes setting of the resolution corresponding to the size of the grid to generate the grid at an interval of 1 km or an interval of 4 km to a region ranging from 33° N to 43° N, and a region ranging from 123° E to 133° E including the Korean peninsula.

4. The method of claim 1, wherein the converting of the digital elevation model data and the albedo data of the earth's surface into the resolution corresponding to the size of the grid includes converting of the digital elevation model data and the albedo data of the earth's surface into the resolution corresponding to the size of the grid to convert the digital elevation model data and the albedo data of the earth's surface according to each predetermined time by performing interpolation or extrapolation depending on each space.

5. The method of claim 1, wherein the converting of the meteorological data into the resolution corresponding to the size of the grid includes converting of the meteorological data into the resolution corresponding to the size of the grid to convert the meteorological data according to each predetermined time by performing interpolation or extrapolation depending on each time.

6. The method of claim 1, wherein the converting meteorological data includes converting at least one of ozone data, aerosol data, precipitable water data, temperature data, atmospheric pressure data, sea-level atmospheric pressure data or cloud data.

7. The method of claim 1, wherein the accumulating of the calculated global solar radiation during a predetermined period includes accumulating the direct solar radiation on a daily, monthly or yearly basis.

8. The method of claim 1, wherein the calculating of the global solar radiation comprises:
calculating a direct solar radiation using the digital elevation model data, the albedo data of the earth's surface and the meteorological data as converted above;
calculating a diffuse solar radiation using the digital elevation model data, the albedo data of the earth's surface and the meteorological data as converted above; and
calculating the global solar radiation using the direct solar radiation and the diffuse solar radiation as calculated above.

9. The method of claim 1, wherein the calculating of the global solar radiation includes calculating the global solar radiation according to each predetermined time.

10. An apparatus of developing a high resolution solar meteorological resource map based on meteorological data comprising:
a resolution setting unit for generating a grid with a predetermined length to a selected region on a map and setting resolution corresponding to a size of the grid;
a basic data processing unit for converting resolution of digital elevation model data, albedo data of the earth's surface into the resolution corresponding to the size of the grid;
a meteorological data processing unit for converting resolution of the meteorological data into the resolution corresponding to the size of the grid;
a solar radiation calculating unit for calculating a global solar radiation using the digital elevation model data, the albedo data of the earth's surface, and the meteorological data as converted above;
a solar radiation processing unit for accumulating the calculated global solar radiation during a fixed period; and
a solar meteorological resource map generating unit for generating a solar meteorological resource map using the accumulated global solar radiation.

11. The apparatus of claim 10, wherein the setting unit generates the grid in a size of a grid used in a geostationary satellite.

12. The apparatus of claim 10, wherein the setting unit generates the grid at an interval of 1 km or an interval of 4 km to a region ranging from 33° N to 43° N, and a region ranging from 123° E to 133° E including the Korean peninsula.

13. The apparatus of claim 10, wherein the basic data processing unit converts the digital elevation model data, and the albedo data of the earth's surface according to each predetermined time by performing interpolation or extrapolation depending on each space.

14. The apparatus of claim 10, wherein the basic data processing unit converts the meteorological data according to each predetermined time by performing interpolation or extrapolation depending on each space.

15. The apparatus of claim 10, wherein the meteorological data are ozone data, aerosol data, precipitable water data, temperature data, atmospheric data, sea-level atmospheric data or cloud data.

16. The apparatus of claim 10, wherein the solar radiation processing unit accumulates the calculated global solar radiation on a daily, monthly or yearly basis.

17. The apparatus of claim 10, wherein the solar radiation calculating unit calculates a direct solar radiation and a solar radiation using the digital elevation model data, the albedo data of the earth's surface and the meteorological data as converted above, and calculates the global solar radiation using the direct solar radiation and the diffuse solar radiation as calculated above.

18. The apparatus of claim 10, wherein the solar radiation calculating unit calculates the global solar radiation according to each predetermined time.
